(19) United States
(12) Patent Application Publication
(10) Pub. No.: US 2017/0265408 A1
(43) Pub. Date: Sep. 21, 2017

(54) Modular Hydroponic Growth System

(71) Applicant: Ponix LLC, Salt Lake City, UT (US)

(72) Inventors: Patrick McGowan, Scituate, MA (US); Daniel Baron, Santa Fe, NM (US); Marcus Baron, Santa Fe, NM (US); Ryan Hafner, Whitehall, PA (US); Hyon Choi, Flushing, NY (US)

(73) Assignee: Ponix LLC, Salt Lake City, UT (US)

(21) Appl. No.: 15/461,179

(22) Filed: Mar. 16, 2017

Related U.S. Application Data
(60) Provisional application No. 62/309,045, filed on Mar. 16, 2016.

(51) Int. Cl. A01G 31/02; A01G 31/04; A01G 1/00

(52) U.S. Cl. CPC A01G 31/02; A01G 1/001; A01G 31/047; A01G 31/042

(57) ABSTRACT

A modular hydroponic growth system is presented which supports a variety of plant growth with flexible conditions. The modularity is supported in part by quick-connect systems which allow liquids and air to be brought to and from subunits in an efficient manner. An advanced HVAC system allows for fresh air to be brought down one wall and stale air to be extracted from an opposing wall. The system allows for automation through the use of intelligent trolleys.

### BACKGROUND

Hydroponic growth systems have to date only been deployed in limited situations, being used for specialized purposes or to grow plants in specific environments. Nevertheless, hydroponic farming offers the possibility of more efficient plant growth (higher productivity) than soil based systems, the ability to grow plants and generate produce in a wide variety of environments, and the ability to grow the produce near its point of final consumption. In addition, hydroponic growth systems allow for the growth of plant species which would not normally survive in a particular climate (e.g. desert or continually frozen environments).

The hydroponic growth systems to date have shown limitations in their ability to provide optimized lighting and delivery of nutrients. In order to scale hydroponic farming appropriately, systems which optimize lighting and nutrient supply are needed. In addition, efficient systems and methods for feeding plants at the various stages of growth (e.g. seedling, cloning, vegetation, and flowering) as well as for monitoring and harvesting, are required. Furthermore, it should be possible to easily scale the hydroponic growth operation.

### SUMMARY

What is presented is a modular hydroponic growth system comprising a plurality of modules including at least one mechanical module which provides liquids to the growth modules, and an interconnect system which allow growth modules to be interchanged. In one embodiment, an HVAC system is further incorporated to flexibly supply air with a corresponding rapid interconnect system to allow interchange of the modules.

In one embodiment, a trolley system is used for automated processing and harvesting. Modules are accessed and growth material can be exchanged and conditions within the growth module monitored.

In one embodiment, air is supplied to the module through a wall which allows air to escape into the module as it travels through the wall. A corresponding wall on an opposite side allows the air to exit. In this way fresh, humidified air can be passed over the vegetation.

What is presented is a hydroponic system which in one aspect has a core for housing plants, the core having a bottom end and a top end. The system has a base portion for receiving the bottom end of the core, as well as for housing nutrients and water. A vertical arm connects to the base and extends to a capping arm to form a C holder which extends from the base portion and which attaches to the top of the core. A motor, which can be housed in the base, rotates the core and exposes the growing materials (plants/produce) to light emanating from a light strip housed in the vertical arm. In one embodiment, the distance between the core and the light strip is varied to control the illumination to the plants.

The lighting emanating from the light strip can be controlled to vary the spectrum of light illuminating the growing materials. In one embodiment different types (colors) of LEDs are used and the colors to the LEDs are controlled by varying the current or the duty cycle of the LEDs. By varying the light emanating from the different color LEDs the temperature and/or spectrum of the light can be controlled and optimized for plant growth. In one embodiment a feedback system is used to vary the spectrum of the light and optimize the light for the particular growth conditions or growth stage of the plants/produce.

Another aspect of the present hydroponic system is the nutrient system, which is comprised of several nutrients and potentially pH control solutions so that the nutrients and pH control solutions can be mixed into a mixing system and dispersed to the plants through the core. In one embodiment, a feedback system is used to monitor one or more parameters of the plants and adjust the nutrients and pH to optimize growth. In one embodiment, nutrient and pH solutions are stored in interchangeable cartridges.

In one embodiment for small plants (typically plants with a full growth height under approximately 7″), a rotating small plant chamber allows up to approximately 40 small plants to grow at the same time, which are growing outward towards the light source, with the nutrients and water being fed up through the chamber in a tube connected to the base reservoir. The nutrients feed all the small plants and any excess drains out the bottom of the chamber back into the reservoir.

In one embodiment for large plants (plants with a full growth height greater than approximately 7″), a rotating vessel (separate from system) containing a large plant grows upward and outward towards the light source, with the nutrients and water being fed into the top of the vessel for drainage into the base reservoir.

In an embodiment for indoor environments, environmental control and artificial lighting are necessary for proper plant growth, so the removable arms with LED light bars are present along with the one-way mirror sheet wraps to enclose the growing environment.

In an embodiment for outdoor environments, natural or supplemental lighting are necessary to plant growth. If there is not enough natural lighting reaching the system, the removable arms with LED light bars are optionally present to ensure that enough light reaches the plants per day.

In an embodiment for automated reservoir monitoring and dosing, the automated reservoir monitoring and dosing engine is on top of the local reservoir, maintaining proper pH levels, nutrient levels, and water height.

In one embodiment, the invention is deployed as a modular frame structure to house a mechanical section/module which provides for solution mixing and monitoring, and one or more growth sections which can be configured for various stages of growth. Multiple growth sections can be configured and operated from a single mechanical section. In one configuration, a single mechanical section is used to support a plurality of growth sections (e.g., 8-16). The growth sections may be located on each side of the mechanical section. The growth sections are equipped with sensors for both the air and water within the sections. CO₂, temperature, and humidity sensors measure the environmental conditions of the air in the section. pH, electroconductivity, and water level sensors measure the water within the section reservoir.

Growth sections can be configured to operate on an automated scheduler, which is specified by a user through a connected software interface. Specified schedules include settings for lights, nutrient dosing, air temperature, air humidity, CO₂ levels, and scheduling for multiple batches of mixed nutrient recipes. In one configuration, multiple growth sections can be configured within, for example, a 20′ ISO container, a 40′ ISO container, two merged 20′ ISO containers, or a collapsible container which can be collapsed and transported in a flat-packed format. In one configuration, multiple growth sections can be stacked on top of each other vertically.

In one embodiment an expandable modular manifold system is used to interconnect the plumbing of the respective modules. In this embodiment, the manifold system interconnects between modules to provide a continuous water feed and drain system, as opposed to having a plurality of pipes which run from the mechanical section/module to each of the growth sections.

In one embodiment, the plant growth can be separated from the growing trough by lifting up the plant growth section up and out of the growing trough. This can accomplished by using a system of winches which can be combined with a rail system that hosts one or more motorized trolleys that can pick up plant growth and relocate it as appropriate.

In another embodiment, various configurations for motorized trolleys are used including a motorized trolley for harvesting/planting, a motorized trolley for monitoring, and a motorized trolley for dosing. In this embodiment the centralized mechanical unit can be eliminated as its function is accomplished through the motorized trolley. Motorized trolleys can be configured to integrate with the automated scheduler for each growth section, which is specified by a user through a connected software interface. Specified schedules include settings for lights, nutrient dosing, air temperature, air humidity, CO₂ levels, and scheduling for multiple batches of mixed nutrient recipes.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 illustrates a perspective view of an example vertical hydroponic growth system, according to one embodiment;

FIG. 2 illustrates a perspective front view of an example base of the example hydroponic growth system of FIG. 1, according to one embodiment;

FIG. 3 illustrates a rear perspective view of an example base of the example hydroponic growth system of FIG. 1, according to one embodiment;

FIG. 4A-B illustrate side views of the example vertical hydroponic system of FIG. 1, according to one embodiment;

FIG. 5 illustrates a side view of an example core of the example vertical hydroponic system of FIG. 1, according to one embodiment.

FIGS. 6A-B illustrate a front view and an exploded view of an example indoor vertical hydroponic growth system for small plants, according to one embodiment;

FIGS. 7A-B illustrate a front view and an exploded view of an example indoor vertical hydroponic growth system for large plants, according to one embodiment;

FIGS. 8A-B illustrate front views of example outdoor vertical hydroponic growth systems for large plants and small plants, according to one embodiment;

FIG. 9 illustrates an exploded view of an outdoor vertical hydroponic growth systems for small plants, according to one embodiment;

FIGS. 10A-B illustrate front views of example indoor vertical hydroponic growth systems for large plants and small plants having grown plants, according to one embodiment;

FIGS. 11A-B illustrate front views of example outdoor vertical hydroponic growth systems for large plants and small plants having grown plants, according to one embodiment;

FIGS. 12A-B illustrate a schematic for example mechanical and growth portions of a modular and scalable hydroponic growth system, according to one embodiment;

FIG. 13 illustrates a perspective view of an example mechanical portion utilized in an example modular and scalable hydroponic growth system, according to one embodiment;

FIG. 14 illustrates a perspective view of an example growth portion utilized for cloning of plants in an example modular and scalable hydroponic growth system, according to one embodiment;

FIG. 15 illustrates a perspective view of an example growth portion utilized for vegetative state of plant growth in an example modular and scalable hydroponic growth system, according to one embodiment;

FIG. 16 illustrates a perspective view of an example growth portion utilized for flowering stage of growth of plants in an example modular and scalable hydroponic growth system, according to one embodiment;

FIG. 17 illustrates a perspective view of an example modular and scalable hydroponic growth system configuration, according to one embodiment;

FIG. 18 illustrates a perspective view of an example system having multiple example modules being joined together using quick connects/disconnects, according to one embodiment;

FIG. 19 illustrates a close-up view of the connection of solution piping and aeration piping between adjacent modules, according to one embodiment;

FIG. 20 illustrates an exploded view of a module that is compatible with a trolley, according to one embodiment;

FIG. 21 illustrates a perspective view of an example section of a modular system compatible with trolleys, according to one embodiment;

FIG. 22 illustrates a close-up view of a modular system compatible with trolleys, according to one embodiment;

FIG. 23 illustrates a perspective view of a modular system compatible with trolleys, according to one embodiment;

FIG. 24 illustrates a perspective view of various different trolleys that could be utilized in a modular system, according to one embodiment;

FIG. 25 illustrates a perspective view of a trolley chassis, according to one embodiment;

FIG. 26 illustrates a perspective view of an example array of modules, according to one embodiment;

FIG. 27 illustrates a top view of the example array of modules of FIG. 26, according to one embodiment;

FIG. 28 illustrates a perspective view of an example airflow within a modular hydroponic growth system, according to one embodiment;

FIG. 29 illustrates a perspective view, including a close-up view, of mixing tank and manifold system used in a modular hydroponic growth system, according to one embodiment;

FIG. 30 illustrates a perspective view of an example trough that may be used within a growth module for deep water culture hydroponic growth, according to one embodiment; and

FIG. 31 illustrates a perceptive view of an example nutrient film technique that may be used within a growth module, according to one embodiment.

### DETAILED DESCRIPTION

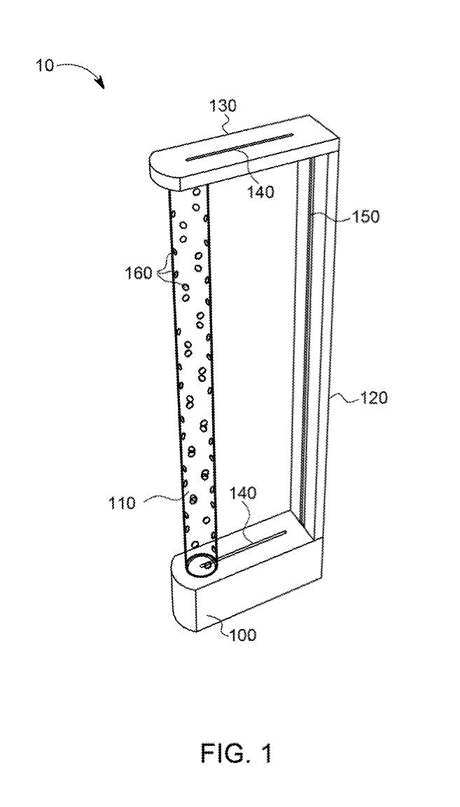

FIG. 1 illustrates a perspective view of an example vertical hydroponic growth system 10. The system 10 includes a base 100, a core 110, a vertical arm 120, and a capping arm 130. The base 100, the vertical arm 120, and the capping arm 130 are configured as a “C” and act to support the core 110. The core 110 includes plant holes 160 to support plants (growing material). The size and orientation of the plant holes 160 may be varied to support a variety of plants. A light strip 150 is resident on the vertical arm 120 and provides lighting for the plants placed in the plant holes 160. A motor (not shown) is used to rotate the core 110 to provide even illumination to the plants which grow out of plant holes 160.

According to one embodiment, the system 10 may be capable of utilizing interchangeable cores, with different cores being used for growing different types of plants. The configuration of the core is not limited to the illustrated example. Alternative core configurations may include cores having multiple vertical sections, or cores having plant holes angled significantly off of the horizontal axis (e.g., pointing upward with support around the holes).

The base 100 and the capping arm 130 include adjustment slots 140. The adjustment slots 140 allow for the distance between the core 110 and the light strip 150 to be varied to control the amount of illumination and provide adequate space while the plants are growing. Having excess space between the light strip 150 and the core 110 can waste light but can also impact the growth of the plants by causing too much growth outward (radially) and not enough growth around the diameter of the core 110. In the illustrated embodiment, the core 110 is moved towards (and away from) the light strip 150 through the adjustment slots 140. In an alternate embodiment, the slots 140 may extend from the light strip 150 and the light strip 150 may be moved towards (and away from) the core 110 which remains at a fixed location. A number of mechanisms can be used to alter the distance between the light strip 150 and the core 110, including stepper motors, belt mechanisms or other electromechanical systems know to one of skill in the art which provide for controlled bidirectional movement along one axis.

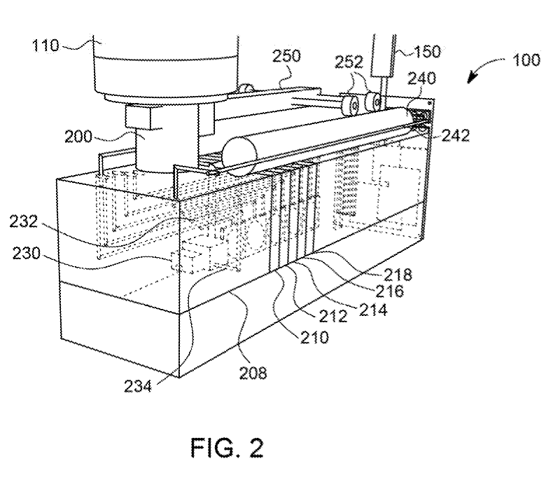

FIG. 2 illustrates a perspective front view of an example base 100 of the example hydroponic growth system 10 of FIG. 1. The base 100 includes a plurality of storage chambers (5 illustrated) 210, 212, 214, 216, 218 and a mixing chamber 208. The storage chambers 210, 212, 214, 216, 218 may store different nutrient solutions and pH control solutions (pH up, pH down). The mixing chamber 208 may receive solutions (nutrients, pH control) from the storage chambers 210, 212, 214, 216, 218 and mix them in order to prepare an appropriate “broth” for the plants housed in the core 110. The broth may be customized for the specific plants, or specific portion of the life cycle of the plants, housed in the core 110 and may be made of different solution combinations and varying amounts of solutions. For example, the nutrients utilized in the broth may be chosen based on their ability to control early stage (e.g. seedling) growth, accelerate growth, or provide specialized nutrients to control particular growth parameters of the plants or to rapidly ripen produce. The pH control solution utilized in the broth is selected so as to keep the pH of the broth correct.

The base 100 also includes a dispersal pump 230 that is used to pump the broth from the mixing chamber 208 to the core 110 through a dispersal line 232. The base 100 may also include a filter 240 that is used to filter the broth. The broth may be feed from the mixing chamber 208 to the filter 240 via a feed line 234 and returned to the mixing chamber 208 via a return line 242.

The base 100 may also include a motor 200 connected to the core 110 for rotating the core 110. In an alternative embodiment, the motor 200 could be located in the capping arm 130 or in the core 110 (requiring moving contacts). The base 100 may also include a support bar 250 and track system 252 that work in cooperation with one another to vary the distance between the core 110 and the light strip 150 by moving the core 110 towards and away from the light strip 150. As previously discussed, in an alternate embodiment the light strip 150 may be moved towards and away from the core 110.

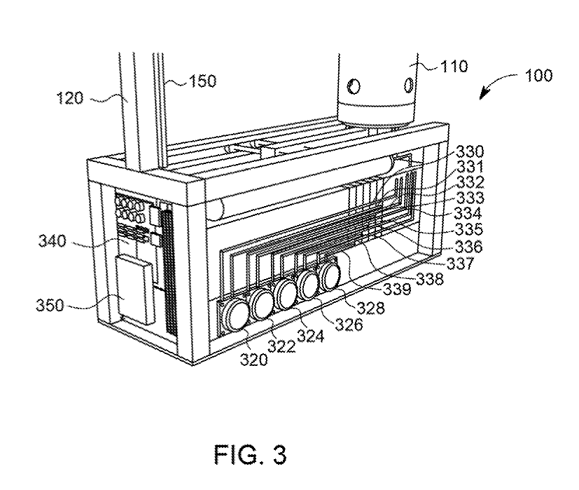

FIG. 3 illustrates a rear perspective view of an example base 100 of the example hydroponic growth system 10 of FIG. 1. The base 100 includes a plurality of pumps (5 illustrated) 320, 322, 324, 326, 328 to pump appropriate solution from their respective storage chambers 210, 212, 214, 216, 218 to the mixing container 208. For example, the pump 320 retrieves a solution (e.g., nutrients) from chamber 210 via input 330 and doses it to the mixing container 208 via output 331. The other pumps 322, 324, 326, 328 retrieve the solutions (e.g., nutrients, pH controls) from the respective chambers 212, 214, 216, 218 via associated inputs 332, 334, 336, 338 and provide to the mixing container 208 via associated outputs 333, 335, 337, 339. In one embodiment, peristaltic pumps are used. Other types of pumps for accurate dosing of solutions can be utilized as will be appreciated by one of skill in the art. Alternatively, gravity feeds for the solutions (e.g., nutrients, pH controls) can be used, with the pumps being replaced by electromechanical control valves.

The base 100 further includes control electronics 340 that may include, for example, a microprocessor 350, memory, and interfaces to the pumps 320, 322, 324, 326, 328 and motor 200. According to one embodiment, the memory may include code that when read and executed by the microprocessor 350 causes the microprocessor 350 to control the operation of the base 100. The operation of the base 100 may include automated control of the distance between the core 110 and the lighting strip 150 and the mixing and disbursement of the nutrients and pH control solutions that form the broth. In an alternate embodiment, the control electronics 340 provide for an interface which allows an operator to control the lighting and broth.

According to one embodiment, a feedback system is employed which monitors one or more growth parameters of the plants and adjusts the lighting and broth appropriately. A fluorometer can be used to measure the chlorophyll fluorescence of the plants. Alternatively, other spectroscopic methods can be used to measure parameters of the reflected light to determine the growth parameters of the plants or chemical composition of the leaves or roots. The height and lateral growth may also be monitored using beam or imaging methods, with light beams being broken as plants grow up, or images of the plants being analyzed to determine their height and/or breadth. In one embodiment the measured parameters are used in conjunction with software to optimize illumination and/or the mixing/delivery of broth based on known characteristics of growth of the particular plants. In an alternate embodiment, the illumination and/or mixing/delivery of growth broth is varied based on empirical measurements and the conditions optimized based on the response of the plants to changes in lighting and growth broth.

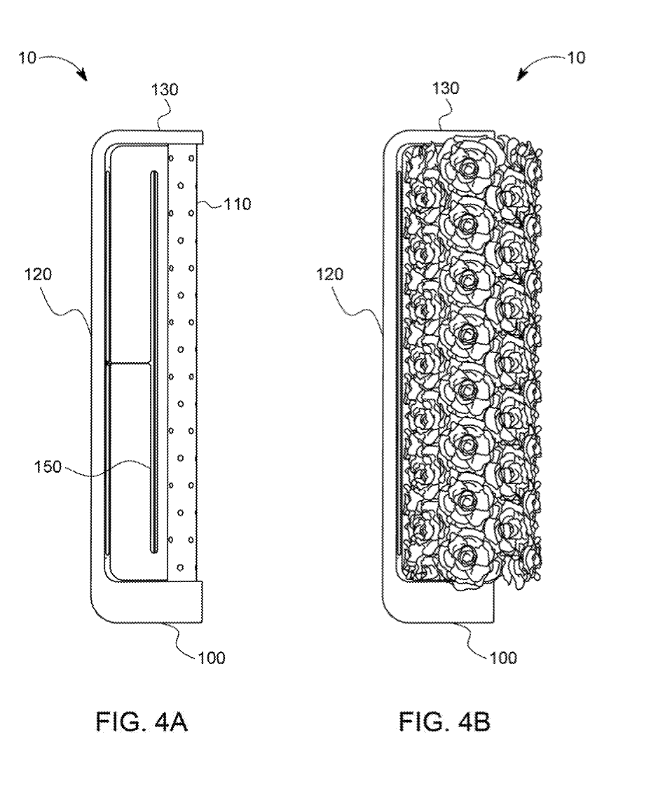

FIG. 4A-B illustrate side views of the example vertical hydroponic system 10 of FIG. 1. FIG. 4A illustrates the system 10 prior to any plant growth with the lighting strip 150 in close proximity to the core 110. FIG. 4B illustrates the system 10 after plants (lettuce) have grown. As can be seen, the space within the system 10 is efficiently used and the core 160 (not visible) accommodates a high density of plants.

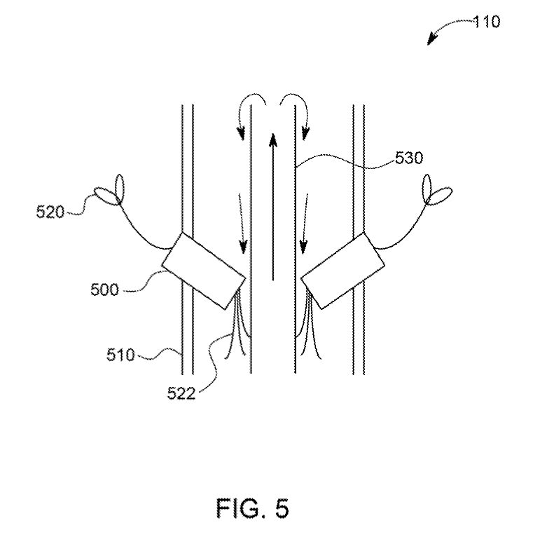

FIG. 5 illustrates a side view of an example core 110 of the example vertical hydroponic system 10 of FIG. 1. The core 110 includes an outer wall 510 and a dispersal tube 530 located within the core 110. The outer wall 510 includes holes 160 (not labeled in FIG. 5) to accommodates seed pods 500. The seed pods 500 hold plants having leaves 520 and a root system 522. The dispersal tube 530 enables the broth to be pumped up to the top of the core 110 inside the tube 530 and then trickle down an outer surface of the tube 530 and contact the root system 522 of the plant.

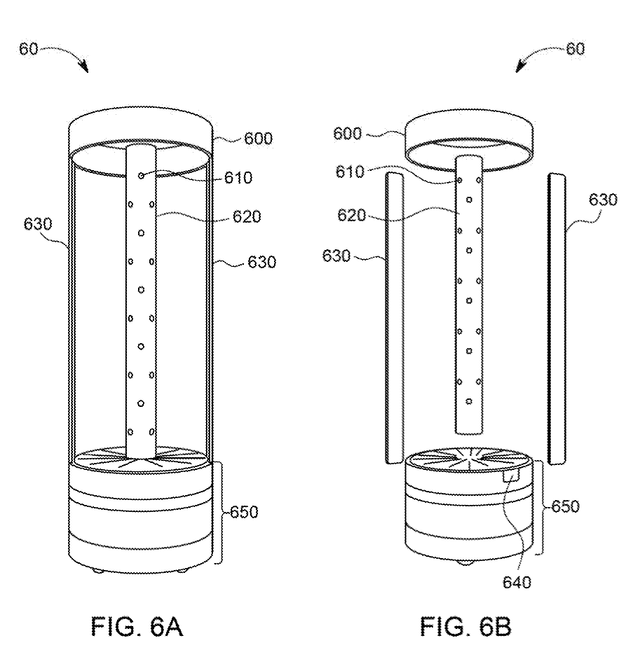

FIGS. 6A-B illustrate a front view and an exploded view of an example indoor vertical hydroponic growth system 60 for small plants. The system 60 includes a capping ring 600, a removable small plant core 620, a base 650 and removable arms 630. The small plant core 620 includes a plurality of small plant holes 610 (e.g., approximately 40) for receiving small plants. The size and orientation of the plant holes 610 may be varied to support a variety of small plants. A plurality of different interchangeable removable small plant cores 620 may be used within the system 60 based on, for example, the type of plants to be grown. The removable arms 630 include LED light bars (not separately identified). The base 650 includes slots 640 for receiving the removable arms 630. The base 650 supports the removable small plant core 620 and the removable arms 630 (within the base slots 640). The removable arms 630 support the capping ring 600. The LED light bars resident on the removable arms 630 provide lighting for the growing material. A motor (not shown) may be used to rotate the base 650 (or at least an upper portion that the small plant core 620 rests on) so that the small plant core 620 and the plants located within the holes 610 receive even illumination. The capping ring 600 acts as a protective ring for the plants (growing material) as well as a structural element for a removable ventilation system that may be included therewith (not illustrated in FIG. 6).

The base 650 may be capable of housing solutions (e.g., water, nutrients, pH control) and feeding the solutions to the small plant core 620 so that the plants supported thereby receive the solutions.

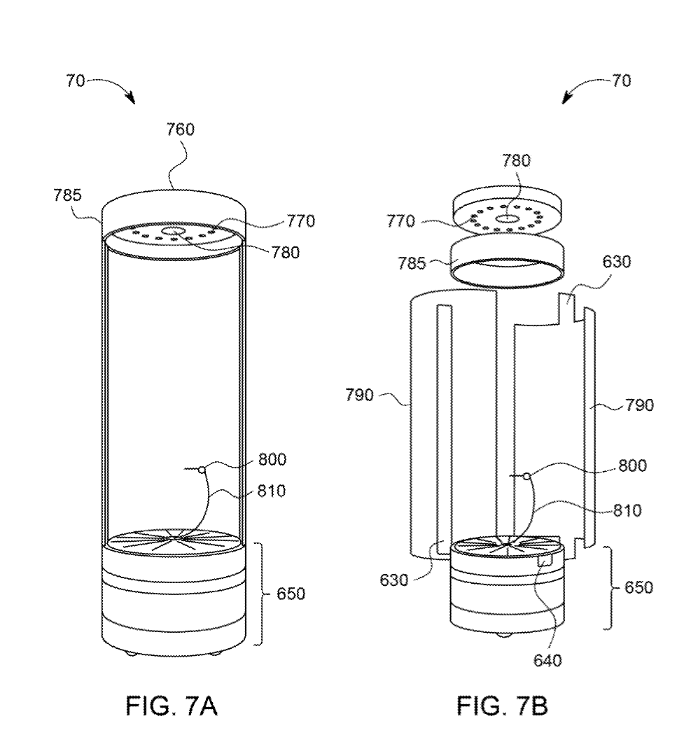

FIGS. 7A-B illustrate a front view and an exploded view of an example indoor vertical hydroponic growth system 70 for large plants. The system 70 includes a base 650, removable arms 630, a capping disc 760 and one-way mirror sheet wraps 790. The one-way mirror sheet wraps 790 can be used to enclose the system 70 and may attach to the removable arms 630 and rest on the base 650. The capping disc 760 includes an automated fan ventilation system 770, an additional LED light cluster 780 and a housing 785. Large plants can be housed and grown out of any vessel (not separately illustrated and not included with the system 70). The vessel may be placed on an upper portion (platform) of the base 650.

The base 650 may be capable of housing solutions (e.g., water, nutrients, pH control) and feeding the solutions to the large plants via a detachable short nutrient feed tube 810 that may be attached to the vessel housing the large plant with a clip 800. The detachable short nutrient feed tube 810 may attaches to a submersible pump (not shown) in a base reservoir (not shown) within the base 650.

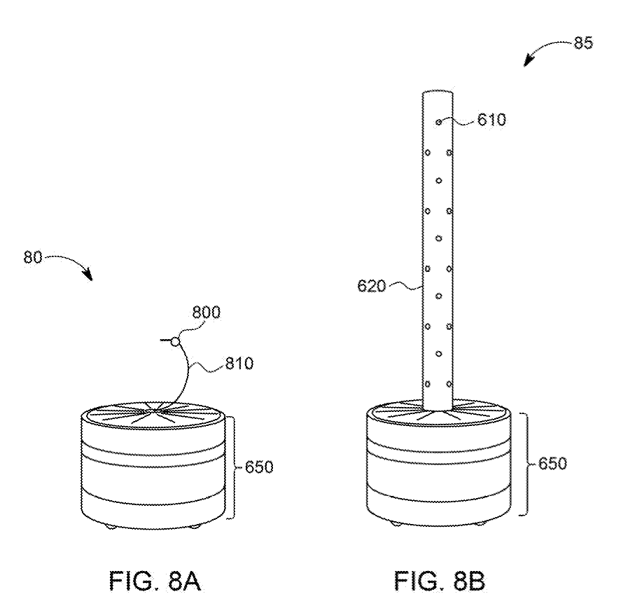

FIGS. 8A-B illustrate front views of example outdoor vertical hydroponic growth systems for large plants 80 and small plants 85. Sunlight is the primary light source for the outdoor systems 80, 85. The system 80 is similar to the system 70 except that it does not include the removable arms 630, the capping disc 760 or the one-way mirror sheet wraps 790. The system 85 is similar to the system 60 except that it does not include the removable arms 630 or the capping disc 760. It should be noted that the removable arms 630 that include LED light bars can be used outdoors for supplemental lighting, using sensors (not shown) to determine how much light is needed to supplement.

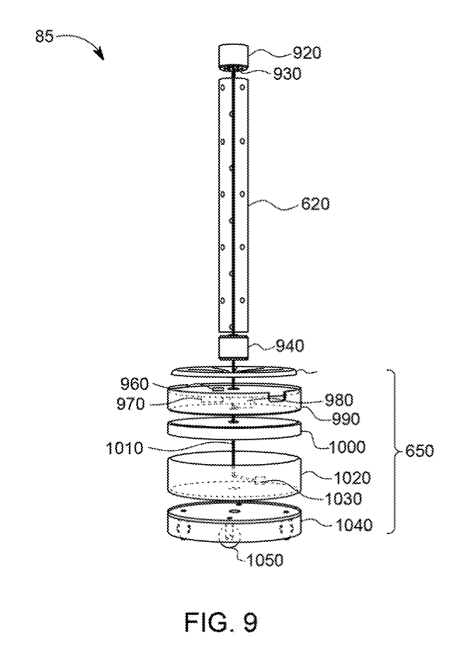

FIG. 9 illustrates an exploded view of an outdoor vertical hydroponic growth systems for small plants 85. The small plant core 620 has an upper cap 920 and a lower cap 940. The upper cap 920 has drain holes 930 for the broth to evenly cascade down the core 620 to the plant roots. The lower drain cap 940 allows excess broth to drain back into the base 650 for recirculation. The base 650 may include a rotating platform 950, a rotation module 990, an automated reservoir monitoring and dosing engine 1000, a removable reservoir 1020 and a transport module 1040. The rotating module 990 includes a motor 970 and a lazy susan gear system 960 to rotate the rotating platform 950 so that the plants housed in the core 620 receive even light. The rotating module 990 may also include a removable drain pipe 980 and a removable water supply solenoid valve (not shown) for discharging water (or broth) into the removable reservoir 1020. The removable drain pipe 980 and a removable water supply solenoid valve may be used for industrial applications.

The removable reservoir 1020 includes a submersible pump 1030 to pump the broth up to the plants through a long nutrient feed tube 1010. The automated reservoir monitoring and dosing engine 1000 monitors the broth, water level, pH levels, and eC levels and applies appropriate doses of nutrients and pH control solution (e.g., pH up/down solutions) from capsules (not shown) using peristaltic pumps (not shown). The various capsules and pumps within the automated reservoir monitoring and dosing engine 1000 can be replaced or swapped out. The nutrient solutions may be chosen based on their ability to control early stage (e.g. seedling) growth, accelerate growth, or provide specialized nutrients to control particular growth parameters of the plants or to rapidly ripen produce. As is readily appreciated, the pH control solutions are used to keep the pH of the broth correct.

According to one embodiment, the automated reservoir monitoring and dosing engine 1000 would not be on each individual system 85 in an industrial scenario. Rather, the automated reservoir monitoring and dosing engine 1000 would be located on a main external reservoir. The automated reservoir monitoring and dosing engine 1000 could also be connected via WiFi to a smartphone/tablet/web application that allows an operator to use an interface to control all light and water features (not shown). According to one embodiment, the engine 1000 may include a microprocessor (not shown) and memory (not shown). The memory may include code that can be read and executed by the microprocessor in order to have the microprocessor perform the various monitoring, dosing and control activities.

The transport module 1040 may include casters 1050 to allow the system 85 to be moved. It should be noted that in certain industrial scenarios the removable small plant core 620 may be taller and outfitted with additional small plant holes to allow for additional plants.

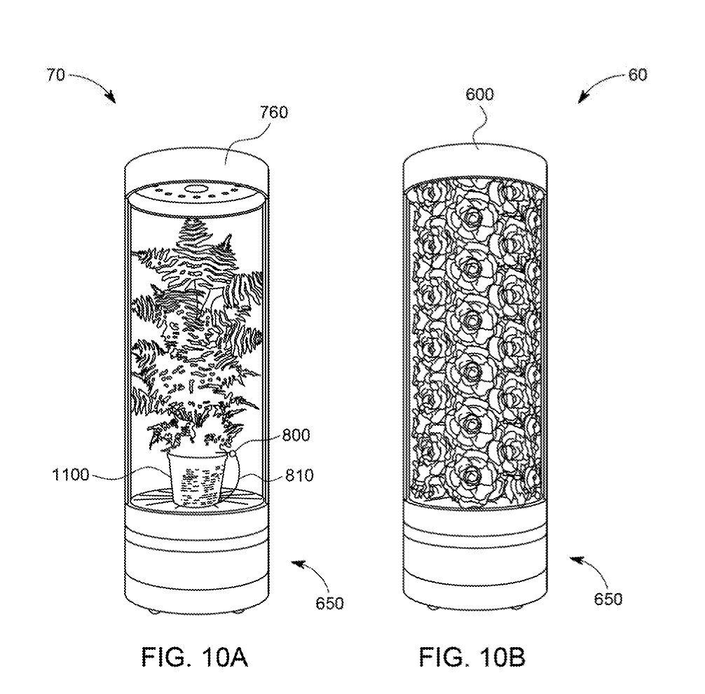

FIGS. 10A-B illustrate front views of example indoor vertical hydroponic growth systems for large plants 70 and small plants 60 having grown plants. The system 70 has a plant grown in a vessel (e.g., pot) 1100 that sits on the base 650. The vessel 1100 may typically have holes in the bottom to allow drainage back into the reservoir in the base 650. The system 60 has plants growing from the core 620 that is not visible due to the growth. It should be noted that the capping ring 600 or capping ring 760, the removable arms 630 and possibly the one-way mirror sheet wraps 790 limit the growth of the plants.

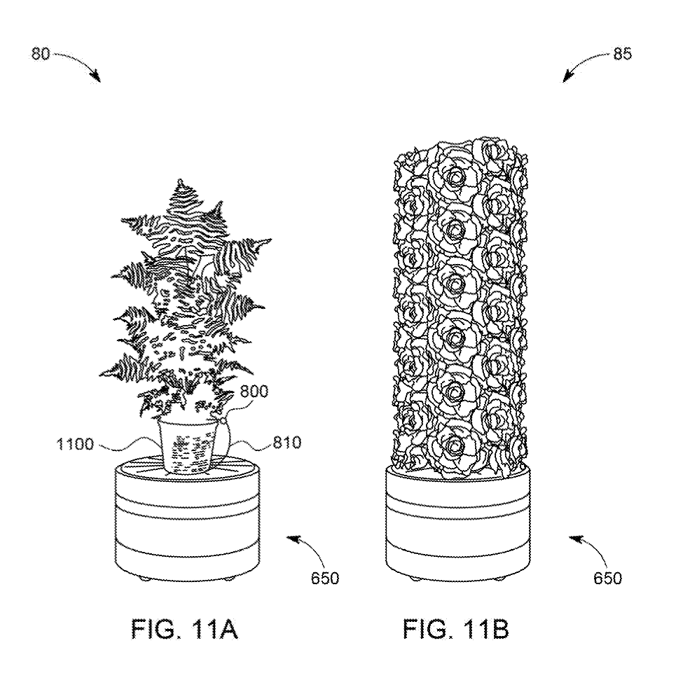

FIGS. 11A-B illustrate front views of example outdoor vertical hydroponic growth systems for large plants 80 and small plants 85 having grown plants. Without the capping ring 600 or capping ring 760, the removable arms 630 or the one-way mirror sheet wraps 790, the plants have unlimited growing space.

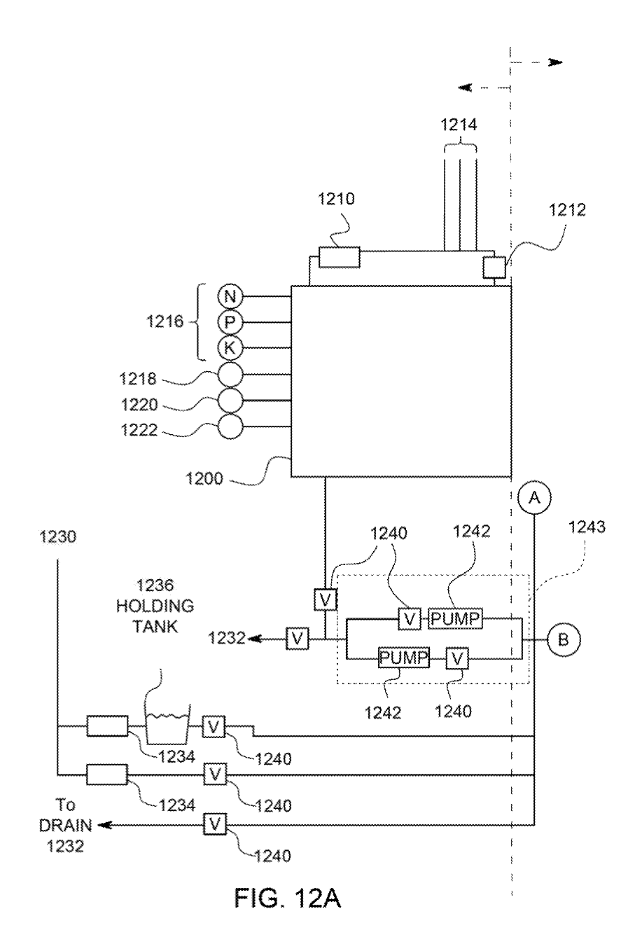

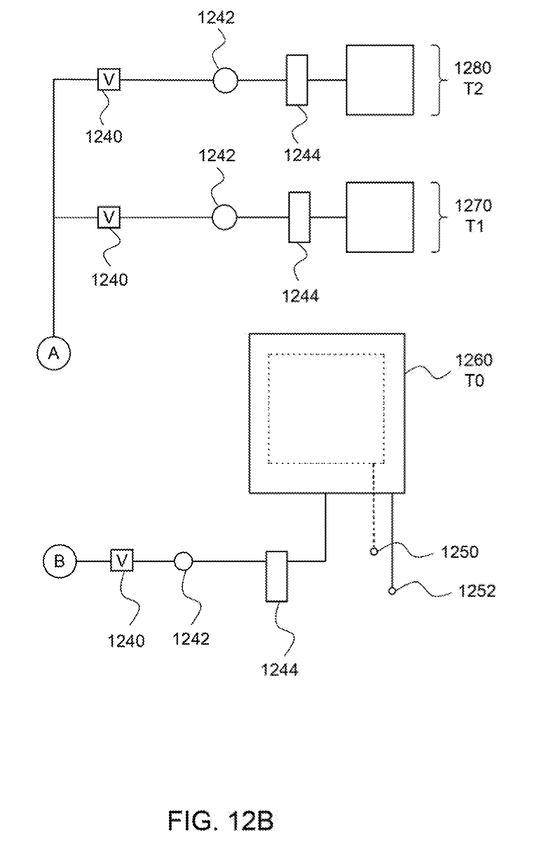

FIGS. 12A-B illustrate a schematic for example mechanical and growth portions of a modular and scalable hydroponic growth system. The mechanical portion of the system is illustrated on FIG. 12A and the growth portion is illustrated on FIG. 12B. The mechanical portion includes a recirculating pump 1210 connected to a mixing tank 1200 for recirculating and mixing of aqueous solutions. A heating element 1212 may be included to bring the solution to an appropriate temperature, and in particular to heat water from a fresh water supply. A sensor manifold 1214 is used to monitor parameters of the solution including, but not limited to pH, electrical conductivity, and temperature. Nutrients 1216 including, but not limited to, Nitrogen, Phosphorus, and Potassium may be provided to the mixing tank 1200. Additional components including, for example, hydrogen peroxide 1218 (for cleansing), magnesium 1220 and calcium 1222 (for re-establishing mineral content) can be added to the mixing tank 1200.

The solution in the mixing tank 1200 can be created using water from a pressurized external water source 1230. According to one embodiment, the water can be filtered using filtration 1234 and a holding tank 1236. Valves 1240 may be used to control flow of the water into the mixing tank 1200. A bi-directional pump and valve assembly 1243 including a set of valves 1240 and pumps 1242 is configured such that water can be pumped into the mixing tank 1200 and solution from the mixing tank 1200 can be pumped out. Solution from the mixing tank 1200 may be pumped to a drain 1232 or to the growth portion (e.g., growing troughs T0 1260, T1 1270, and T2 1280).

The growth portion includes one or more growth troughs (3 illustrated) T0 1260, T1 1270, and T2 1280. Because the system is modular, additional troughs can be added and additional features may be added to some, or all, of the troughs 1260, 1270, 1280. For example, in the illustrated embodiment, trough T0 1260 includes a light 1250 and a water level sensor 1252. Each trough 1260, 1270, 1280 can be supported with a valve 1240, flow sensor 1242 and sediment filter 1244. The number of troughs that can be supported is primarily limited by the pumping capability of the system and can run into the hundreds. In one embodiment 32 troughs are supported.

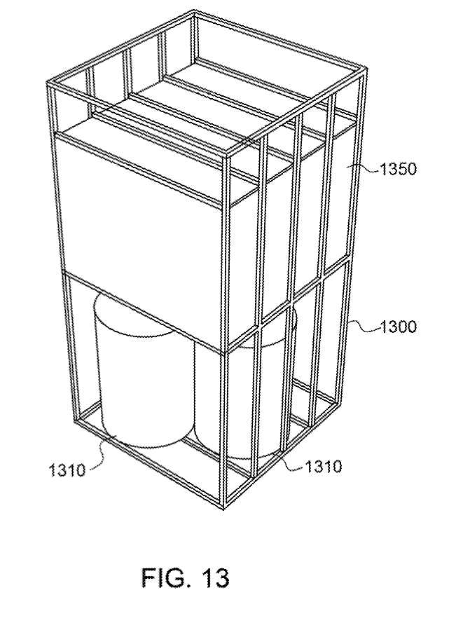

FIG. 13 illustrates a perspective view of an example mechanical portion utilized in an example modular and scalable hydroponic growth system. The mechanical portion includes a frame 1300 housing a mechanical assembly 1350 (e.g., functionality illustrated in FIG. 12A such as mixing tank 1200, pump 1210, heater 1212) on an upper level and storage containers 1310 housing, for example, nutrients on a lower level.

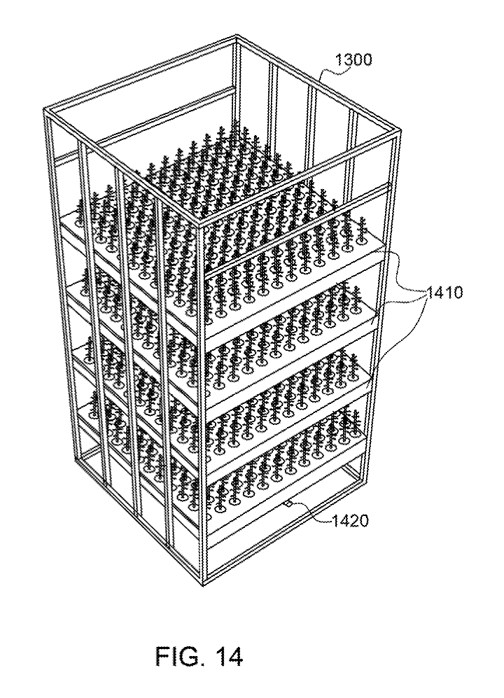

FIG. 14 illustrates a perspective view of an example growth portion utilized for cloning of plants in an example modular and scalable hydroponic growth system. The growth portion includes the frame 1300 housing a plurality of cloning trays 1410 that are used to allow plants to develop root systems and to support the cloning process until the plants are ready to be transferred to a vegetation stage. Solution feeds (not illustrated) and drain 1420 are present to allow solution to be placed into and removed from cloning trays 1410. Typically, light is not required for the cloning stage.

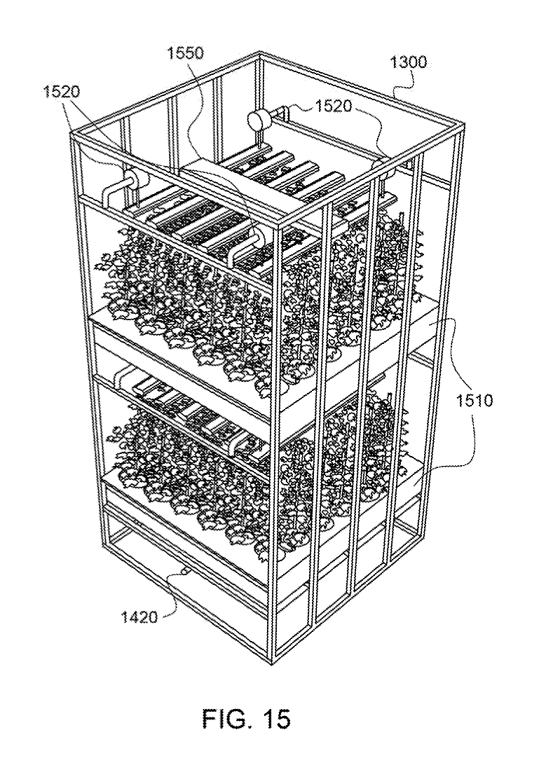

FIG. 15 illustrates a perspective view of an example growth portion utilized for vegetative state of plant growth in an example modular and scalable hydroponic growth system. The growth portion includes the frame 1300 housing a plurality of vegetation trays 1510. A light assembly 1550 is configured over each vegetation tray 1510. According to one embodiment, the frame 1300 includes winches 1520 that are used to raise/lower the light assembly 1550 as required as the plants are growing. Solution feeds (not illustrated) and drain 1420 are present to allow solution to be placed into and removed from vegetation trays 1510.

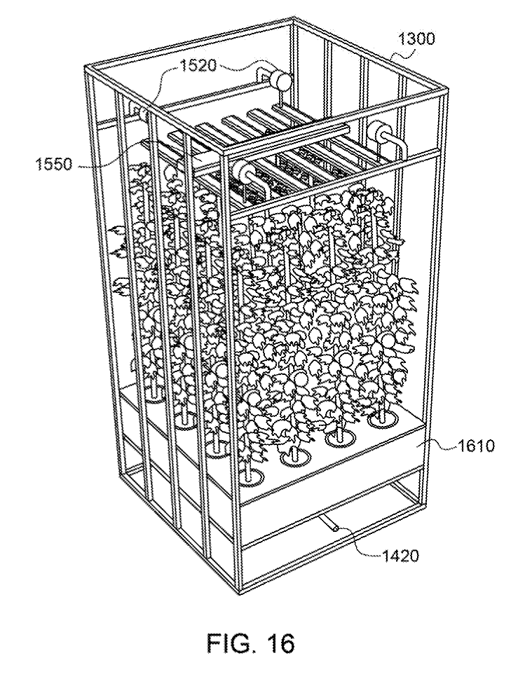

FIG. 16 illustrates a perspective view of an example growth portion utilized for flowering stage of growth of plants in an example modular and scalable hydroponic growth system. The growth portion includes the frame 1300 housing a flowering tray 1610 containing a plurality of flowering plants. As in the configuration for the vegetative state, a light assembly 1550 is configured over flowering tray 1610 and can be raised and lowered using winches 1520.

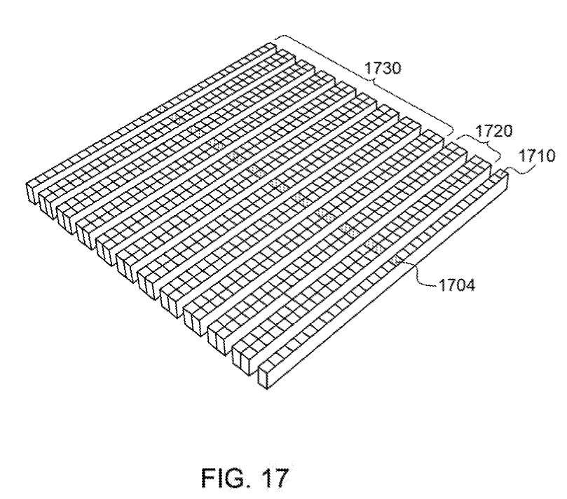

FIG. 17 illustrates a perspective view of an example modular and scalable hydroponic growth system configuration. The system includes a plurality of rows and columns of modular sections (e.g., frames 1300). The illustrated system includes a row of mechanical modules 1704 in the middle of the system. The mechanical modules 1704 may include the functionality illustrated in FIG. 12A, such as mixing tanks 1200, pumps 1210, and heaters 1212. The mechanical modules 1704 may support a plurality of growth units both above and below the mechanical modules 1704. According to one embodiment, at least a subset of the mechanical modules 1704 may include Heating Ventilation and Air Conditioning (HVAC). According to an alternative embodiment, the HVAC functionality is contained in its own modules and is separate from the mechanical modules.

The system may include a plurality of cloning modules 1710, vegetation modules 1720, and flowering modules 1730. As illustrated, the growth modules are organized in columns. In one embodiment, openings/aisles are left between rows of modules to allow access to the plants as well as for general access to the module.

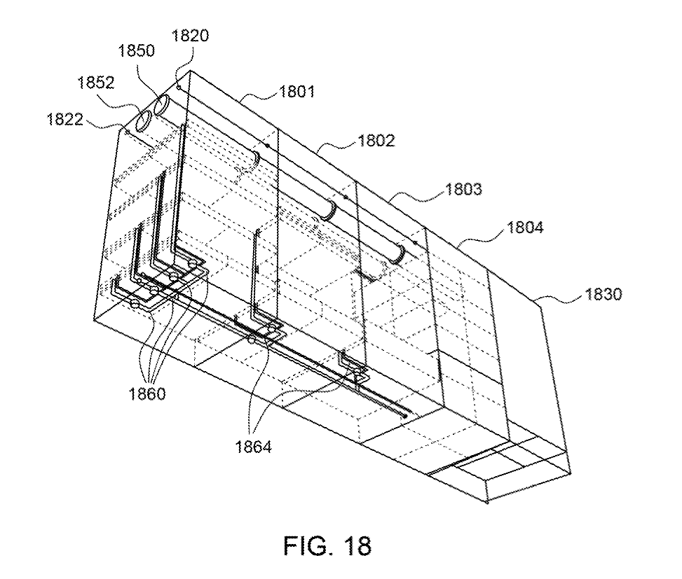

FIG. 18 illustrates a perspective view of an example system having multiple example modules being joined together using quick connects/disconnects. As illustrated, the system includes a cloning module 1801 (e.g., FIG. 14), a vegetation module 1802 (e.g., FIG. 15), a flowering module 1803 (e.g., FIG. 16), a mechanical module 1804 (e.g., FIG. 13), and an HVAC module 1830 all aligned and abutting the adjacent modules. The system utilizes quick connect/disconnect piping, tubing and conduits so as to facilitate interconnection of the modules 1801, 1802, 1803, 1804, 1830 without the need to have an independent set of pipes, cables and conduits that run underneath the modules from a centralized location. The pipes, tubes, cables and conduits may be self-contained within each module, and interconnected to each other when the modules abut one another.

Specifically, the modules may include an electrical feed 1820, a gas feed 1822 (for CO₂ or other gases), an exhaust duct 1850, an intake duct 1852, solution piping 1860 and aeration piping 1864 (for moving solution and air/gas into and out of the troughs). As illustrated, the electrical feed 1820, the gas feed 1822, the exhaust duct 1850 and the intake duct 1852 are located on the top of the modules and the solution piping 1860 and aeration piping 1864 are located on the bottom and sides of the modules, but are in no way intended to be limited thereby. The various pipes, cables and conduits 1820, 1822, 1850, 1852, 1860, 1864 may be configured with quick connects/disconnects which are fittings or terminations, typically with a flange, which allows the sections of conduit/tubing/ductwork to be rapidly and securely interconnected.

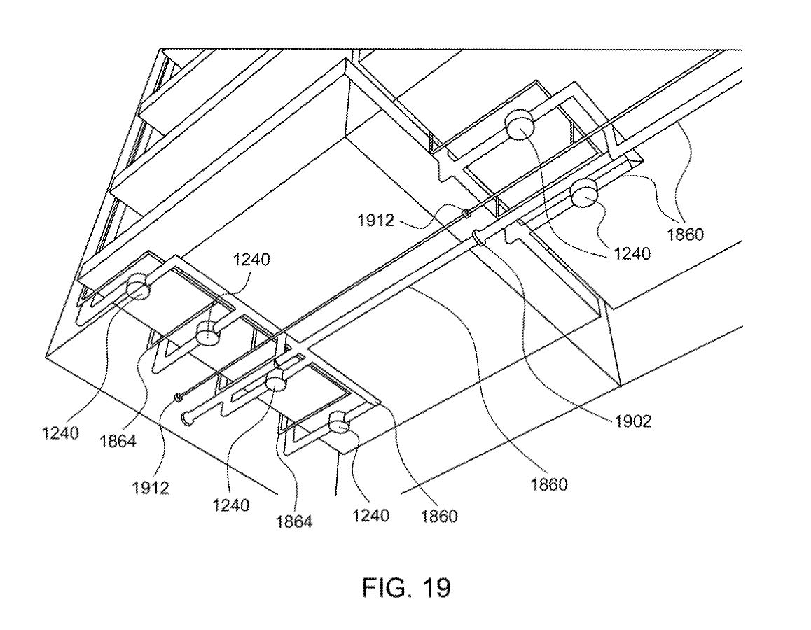

According to one embodiment, the exhaust duct 1850 and/or the intake duct 1852 may include multiple ducts (illustrated in more detail below in FIG. 19).

FIG. 19 illustrates a close-up view of the connection of the solution piping 1860 and the aeration piping 1864 between adjacent modules. The solution piping 1860 extends across the modules and each side of the piping 1860 includes a quick connect/disconnect 1902 that are used to connect the piping 1860 of adjacent modules. As illustrated, the piping 1860 branches out on the left side of the modules so that the solution can be provided to the various trays contained therewithin. The right module (e.g., a vegetation module 1802) has 2 branches and the left module (e.g., a cloning module 1801) has four branches. As illustrated, each of the branches includes a valve 1240 for controlling flow. The aeration piping 1864 extends across the modules and each side of the piping 1864 includes a quick connect/disconnect 1912 that are used to connect the piping 1864 of adjacent modules. As illustrated, the piping 1864 branches out on the left side of the modules with the right module (e.g., a vegetation module 1802) having 2 branches and the left module (e.g., a cloning module 1801) having four branches.

As previously discussed, the embodiments illustrated in FIGS. 18 and 19 allow for modules, of varying types, to be abutted to one another and for the connections for electricity, air (including heating and cooling) and liquid solutions to be readily established without a separate and centralized plumbing and electrical system.

Trolleys may be used instead of, or in addition to, the internal pipes, tubes, cables and conduits trolley to service the various modules within the modular system. The trolleys may move in the aisles between the modules and perform various tasks including, but not limited to, dosing, monitoring, and harvesting.

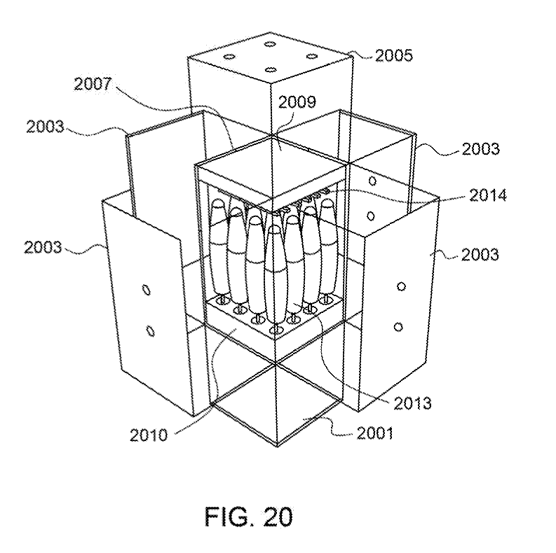

FIG. 20 illustrates an exploded view of a module that is compatible with a trolley. The module includes a floor panel 2001, wall panels 2003, ceiling panel 2005, frame 2007, HVAC unit 2009, growing trough 2010, plant housings 2013, and LED lights 2014. The module can be configured to have standardized dimensions (e.g., 4′×4′×8′).

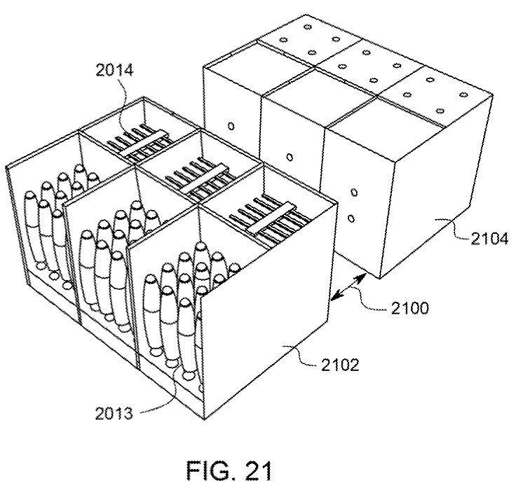

FIG. 21 illustrates a perspective view of an example section of a modular system compatible with trolleys. The system includes two arrays of modules 2102, 2104 separated by an aisle 2100. Each of the arrays 2102, 2104 are illustrated as including 6 modules in a 2×3 array (but are in no way intended to be limited thereby). The array 2102 is an open view of the modules (showing the plant housings 2013 and lights 2014) and the array 2104 is a closed view. The aisle 2100 is dimensioned so as to allow a trolley (automated or human pushed) and human access to the modules within the arrays 2102, 2104.

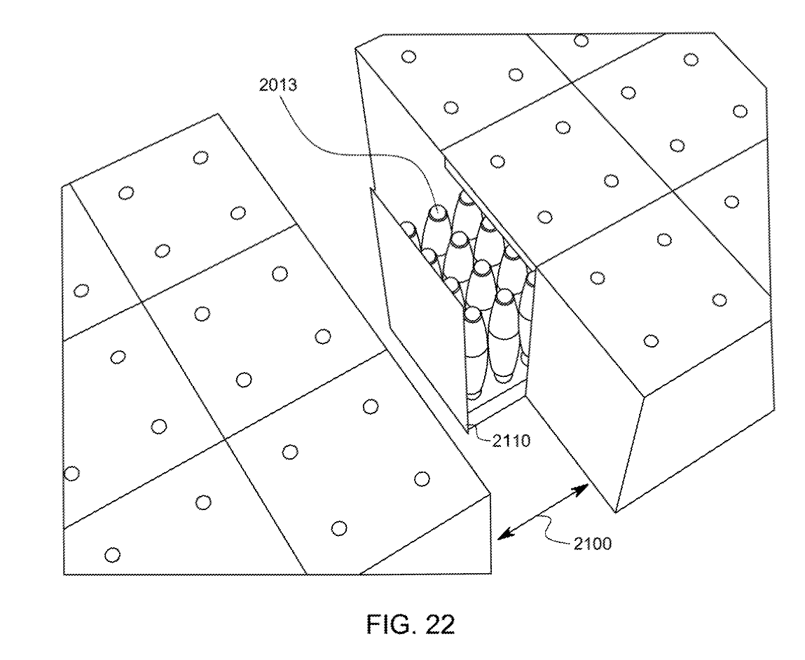

FIG. 22 illustrates a close-up view of a modular system compatible with trolleys. As illustrated, a door cabinet 2110 of one of the modules is open to provide access the plant housings 2013 or troughs contained therein. The access may be by an automated trolley system via the aisle 2100.

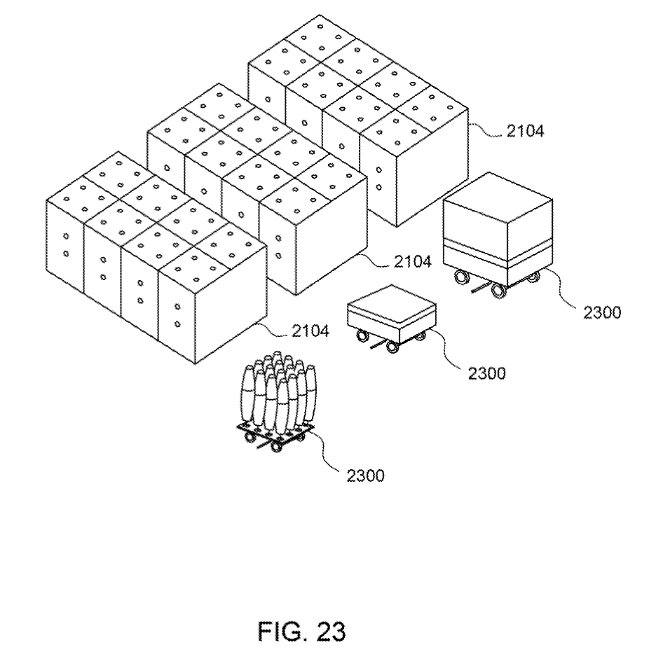

FIG. 23 illustrates a perspective view of a modular system compatible with trolleys. The system includes 3 arrays of modules 2104 (each array consisting of 8 modules configured in a 2×4 arrangement) and a plurality of different purpose trolleys 2300 that could be operated in the aisles between the arrays 2104.

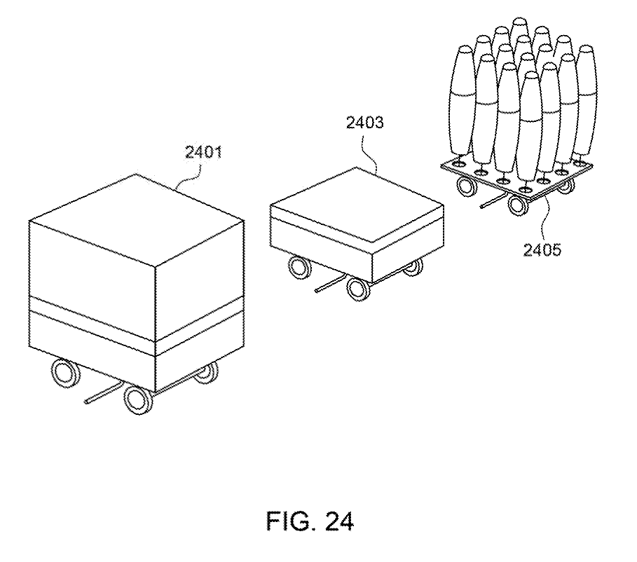

FIG. 24 illustrates a perspective view of various different trolleys that could be utilized in a modular system. A trolley 2401 may include, for example, a tank (not labeled) and pumps (not labeled) and be configured for dosing the modules with an appropriate broth. A trolley 2403 may include, for example, monitoring equipment (not labeled) and be configured for monitoring the various factors (growth, pH, broth, air flow) associated with the module and make a determination as to any changes required. A trolley 2405 may include, for example, a floor capable of holding plant housings and be configured for harvesting crops or placing new plant housings within a module.

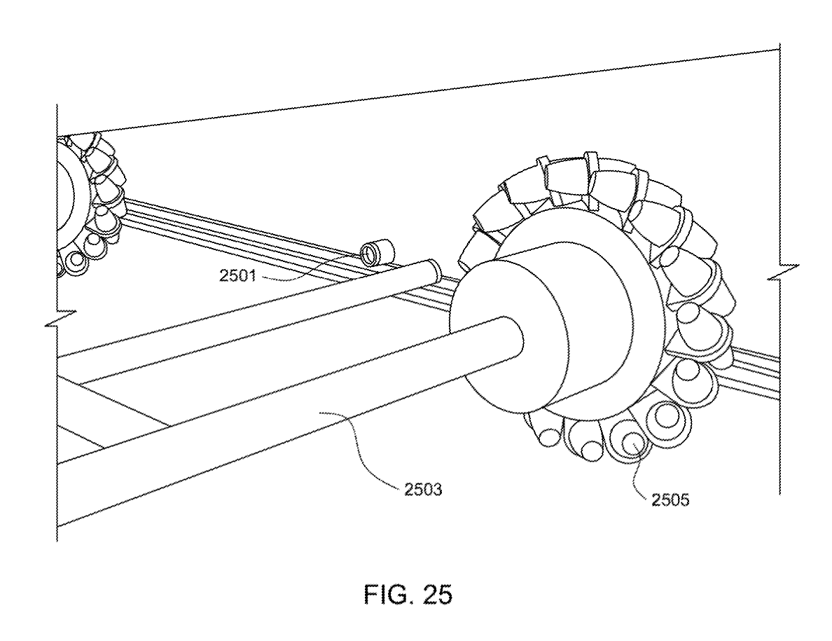

FIG. 25 illustrates a perspective view of a trolley chassis. The chassis includes an axel 2503, gear assembly 2505, and magnetic plumbing connect 2501. The rapid interconnect system previously described can be used in conjunction with the trolley system such that the trolleys can rapidly access and interconnect into the modules to supply or exchange fluids and air.

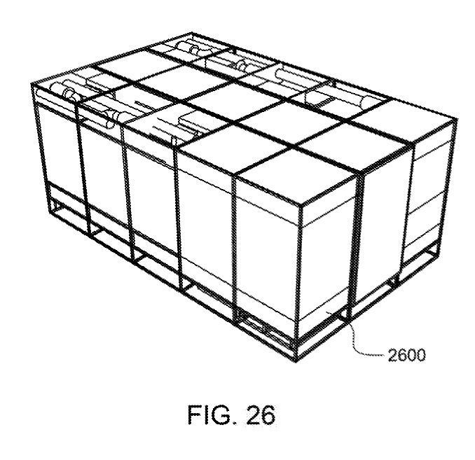

FIG. 26 illustrates a perspective view of an example array of modules. The array may include a plurality of grow modules and a plurality of mechanical modules. The example array be utilized as a “fruit/veggie vault” and may be approximately 20 feet

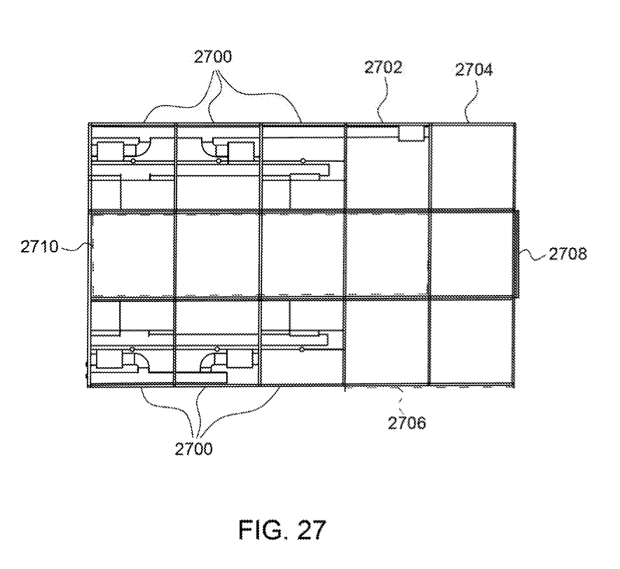

FIG. 27 illustrates a top view of the example array of modules of FIG. 26. The array includes a plurality of flowering modules 2700 (illustrated as three on top row and three on bottom row), a vegetative module 2702 (illustrated on top row abutting last one of flowering modules 2700), processing space 2704 (illustrated on top row abutting vegetative module 2702), mechanical modules (possibly HVAC) 2710 (illustrated in middle row), a brain module 2706 (illustrated as two modules on bottom row abutting last one of flowering modules 2700), and an entrance module 2708 (illustrated in middle row). The flowering modules 2700 and the vegetative module 2702 may have their piping, cable, tubes, conduits and the like quick connected to one another. The processing space 2704 may be an open space or a space having various tools or the like that can be utilized for manipulation of troughs and produce at various stages. The brain module 2706 may include a mixing tank, nutrients, and electrical and control components as previously described with respect to FIG. 12. The entrance 2708 may provide access to the mechanical modules 2710. It should be noted that the configuration of the array is in no way limited to that illustrated. For example, the type, amount and/or location of the various modules (including the growth modules) could be changed without departing from the current scope of the invention.

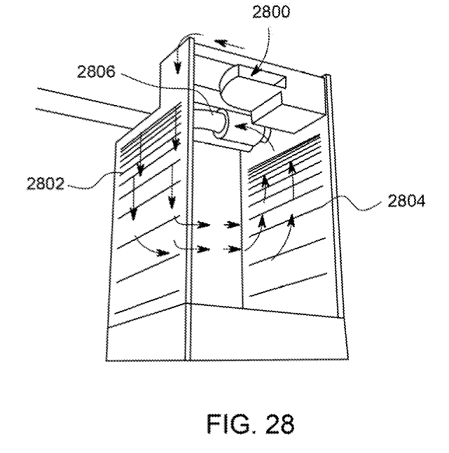

FIG. 28 illustrates a perspective view of an example airflow within a modular hydroponic growth system. To facilitate airflow, the system may include an intake 2800, an air delivery wall 2802, an air exhaust wall 2804 and an exhaust 2806. The intake 2800 is to intake air and deliver the air to the delivery wall 2802. The air may exit the air delivery wall 2802 and pass across the chamber (through the produce). After the air passes across the chamber, it exits through the air exhaust wall 2804 and the exhaust 2806. The air delivery wall 2802 and the air exhaust wall 2804 are designed such that the air flows in the wall till reaching an area where there are multiple exits (on the inside of the wall facing the chamber). The horizontal lines represent the density of air in the walls, which decreases as it exits the wall in the case of air delivery wall 2802 and increase in density as air accumulates in air exhaust wall 2804.

A variety of permeable wall structures can be used to circulate the air including walls having holes in the inside wall. This air circulation can be used in conjunction with the electronics to control and maintain the appropriate temperature and humidity within the growth module. In one embodiment a humidity and temperature (humiTemp) sensor is incorporated in the exhaust panel.

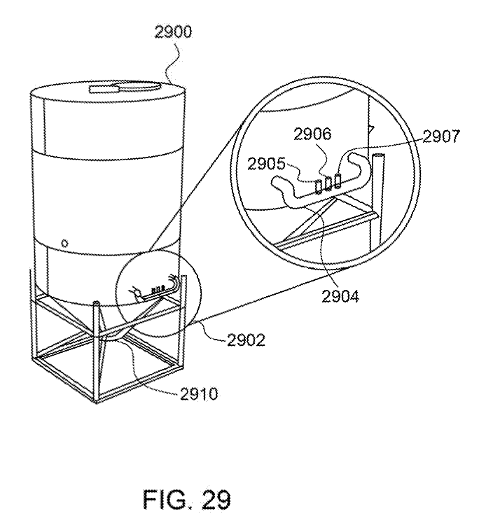

FIG. 29 illustrates a perspective view, including a close-up view, of mixing tank and manifold system used in a modular hydroponic growth system. A mixing tank 2900 used to mix various nutrients and house the mixture includes a manifold 2902. The manifold 2902 includes U-trap plumbing 2904 having a plurality of sampling ports (3 illustrated) 2905, 2906, 2907. The sampling ports 2905, 2906, 2907 may be utilized to monitor, for example, pH, electrical conductivity (EC) and temperature. The mixing tank 2900 may include a cone bottom 2910 to ensure all liquid is shipped when dosing troughs. In one embodiment the cone is built into the floor to maximize space.

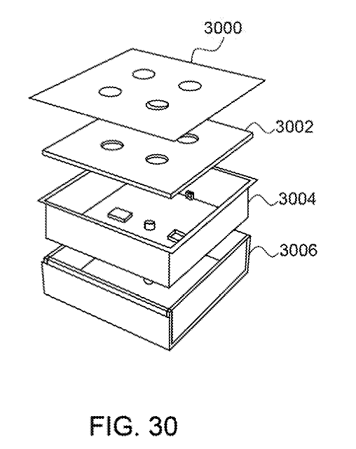

FIG. 30 illustrates a perspective view of an example trough that may be used within a growth module for deep water culture hydroponic growth. The trough includes a trough cap 3000, trough platform 3002, trough 3004, and trough cabinet 3006. In one embodiment trough cap 3000 is an insulated sheet (e.g. stainless steel) and can have a built-in housing for a water level sensor.

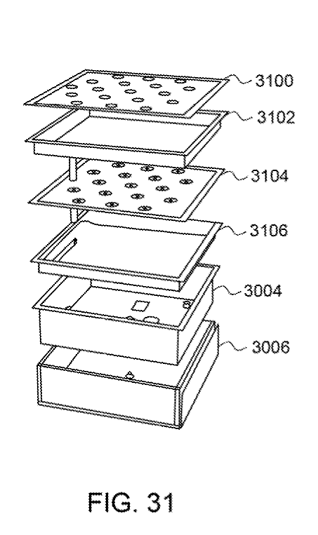

FIG. 31 illustrates a perceptive view of an example nutrient film technique that may be used within a growth module. The method includes using a plurality (e.g., 2-6) of nutrient film technique shelves. The trough includes a 1^{st} nutrient film technique platform 3100, a 1^{st} nutrient film technique shelf 3102, a second nutrient film technique platform 3104 and a 2^{nd} nutrient film technique shelf 3106 that may be housed in a trough 3004 and trough cabinet 3006.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. As such, those skilled in the art will appreciate that the conception, upon which this disclosure is based, may readily be utilized as a basis for the designing of other structures, methods, and systems for carrying out the several purposes of the present invention.

The description above and the accompanying drawings may reference and depict specific and relative dimensions and configurations of the invention, as well as referencing specific constituent materials and uses for the invention. The invention, however, is not limited to those dimensions, materials, or uses. The dimension and configuration choices made in the description and the accompanying drawings were merely descriptive and do not serve to limit the invention to those dimensions. Although the invention has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

It is important, therefore, that the claims be regarded as including such equivalent constructions insofar as they do not depart from the spirit and scope of the present invention. The various embodiments are intended to be protected broadly within the spirit and scope of the appended claims.

1. A modular system for hydroponic growth comprising:
a plurality of growth modules;
at least one mechanical module providing a solution to the growth modules; and
an interconnect system for quick interconnecting of the plurality of growth modules and the at least one mechanical module.

2. The modular system of claim 1, further comprising an HVAC module for providing controlled air to each of the plurality of growth modules.

3. The modular system of claim 1, wherein each of the plurality of growth modules is configured to select a desired amount of the solution to be received.

4. The modular system of claim 1, wherein each of the plurality of growth modules has a microprocessor based monitoring and dosing unit for determining and controlling amount of the solution to be received.

5. The modular system of claim 1, wherein the at least one mechanical module includes at least one sensor to monitor parameters for the solution including at least some subset of group of pH, electrical conductivity, and temperature.

6. The modular system of claim 1, wherein the plurality of growth modules include at least one of a plurality of interchangeable trays, wherein the interchangeable trays are selected from cloning trays, vegetative state trays and a flowering tray.

7. The modular system of claim 6, wherein the plurality of growth modules further includes lighting.

8. The modular system of claim 7, wherein the plurality of growth modules further includes winches for adjusting location of the lighting.

9. A modular system for hydroponic growth comprising:
a plurality of configurable growth modules;
at least one mechanical module providing liquids to the plurality of configurable growth modules; and
a trolley system for interchanging one or more of the plurality of configurable growth modules in an automated fashion.

10. The modular system of claim 9, wherein the plurality of configurable growth modules and the at least one mechanical module are configured in an array of rows and columns.

11. The modular system of claim 9, wherein the trolley system is further capable of monitoring and dosing the plurality of configurable growth modules.

12. The modular system of claim 9, wherein the system includes a plurality of arrays separated by aisles having a width to allow the trolley system to traverse.

13. A modular growth chamber for hydroponic growth comprising:
a frame structure forming a growth chamber therewithin;
at least one growth tray housed within the growth chamber;
a first wall for delivering fresh air to the at least one growth tray within the growth chamber; and
a second wall for exhausting air from the growth chamber.

14. The modular growth chamber of claim 13, further comprising:
an air intake for supplying fresh air to the first wall; and
an air exhaust for removing air from the second wall.

15. The modular growth chamber of claim 13, wherein
the first wall is configured with a series of openings on an internal side for the delivery of the air to the growth chamber; and
the second wall is configured with a series of openings on an internal side for the exhausting of the air from the growth chamber.

16. The modular growth chamber of claim 15, wherein
the series of openings on the first wall have varying spacing from top to bottom to control the level of airflow to the chamber with respect to a vertical position within the chamber; and
the series of openings on the second wall have varying spacing from top to bottom to control the level of airflow from the chamber with respect to a vertical position within the chamber.

17. A growth chamber for hydroponic growth comprising:
a platform for housing one or more plants, wherein the platform is capable of rotating;
an automation system for monitoring the one or more plants and broth for feeding the plants and controlling dosing of the plants; and
a pump for providing the broth to the one or more plants.

18. The growth chamber of claim 17, further comprising a reservoir for housing the broth.

19. The growth chamber of claim 17, further comprising a transportation module with wheels for moving the chamber.

20. The growth chamber of claim 17, further comprising a core resting on and extending vertically from the platform, wherein the core includes a plurality of holes formed therein for receiving plants.

21. The growth chamber of claim 17, further comprising at least one lighting module extending vertically from the platform for lighting the plants.

22. The growth chamber of claim 21, further comprising one-way mirror sheet wraps around the chamber.

23. The growth chamber of claim 17, further comprising a lid having ventilation.
